(19) United States
(12) Patent Application Publication
(10) Pub. No.: US 2016/0035273 A1
(43) Pub. Date: Feb. 4, 2016

(54) ELECTROLUMINESCENT DEVICE

(71) Applicant: Gentex Corporation, Zeeland, MI (US)

(72) Inventors: John A. VanderPloeg, Zeeland, MI (US); William L. Tonar, Holland, MI (US); Ethan J. Lee, Byron Center, MI (US)

(21) Appl. No.: 14/814,532

(22) Filed: Jul. 31, 2015

Related U.S. Application Data
(60) Provisional application No. 62/032,011, filed on Aug. 1, 2014.

(51) Int. Cl. G09G 3/30; G09G 5/10

(52) U.S. Cl. CPC G09G 3/30; G09G 5/10; G09G 2300/04; G09G 2380/10

(57) ABSTRACT

A display device for a vehicle is disclosed. The display comprises at least one transparent element having a profile shape. A reflective element abuts a first surface of the transparent element. An electroluminescent element is proximate the reflective element, and an electrochromic element is proximate the electroluminescent element. The electroluminescent element is substantially transparent in an inactive state and configured to illuminate at least a portion of a symbol in response to receiving a driving current.

### CROSS REFERENCE TO RELATED APPLICATIONS

This Application claims priority of U.S. Provisional Application No. 62/032,011, filed on Aug. 1, 2014, and the entirety of which is incorporated by reference herein.

### TECHNOLOGICAL FIELD

The disclosure relates to a display for a vehicle and more specifically to a display device configured to illuminate at least a portion of the display.

### BRIEF SUMMARY

According to one aspect of the present disclosure, a display device for a vehicle is disclosed. The display comprises at least one transparent element having a profile shape. A reflective element abuts a first surface of the transparent element. An electroluminescent element is proximate the reflective element, and an electrochromic element is proximate the electroluminescent element. The electroluminescent element is substantially transparent in an inactive state and configured to illuminate at least a portion of a symbol in response to receiving a driving current.

According to another aspect of the present disclosure, a reflective display device for a vehicle having a stacked configuration is disclosed. The display device comprises a reflective electroluminescent assembly. The electroluminescent assembly comprises a reflective element, an electroluminescent element, and an electrochromic element. The electroluminescent element forms an electroluminescent feature proximate the reflective element. The electrochromic element is disposed proximate the electroluminescent element. The display device further comprises at least one transparent element forming a display surface of the reflective electroluminescent assembly. The electroluminescent element is configured to display the electroluminescent feature on the display surface in response to an electrical signal. The electroluminescent element is further configured to transmit light from the display surface, reflected from the reflective element, and through the electroluminescent element in an idle state.

According to yet another aspect of the present disclosure, a reflective display device for a vehicle is disclosed. The display device comprises a reflective electroluminescent assembly. The reflective electroluminescent assembly comprises a reflective element, an electroluminescent element, and an electrochromic element. The electroluminescent element forms an electroluminescent feature proximate the reflective element and the electrochromic element is disposed proximate the electroluminescent element. The display device further comprises at least one transparent element forming a display surface of the reflective electroluminescent assembly. The electroluminescent element comprises a plurality of segments configured to emit light forming at least one symbol.

These and other features, advantages, and objects of the present disclosure will be further understood and appreciated by those skilled in the art by reference to the following specification, claims, and appended drawings.

### BRIEF DESCRIPTION OF THE DRAWINGS

FIG. 1 is a projected view of a vehicle interior comprising a display device configured to provide a rearward view from the vehicle;

FIG. 2 is a detailed front view of a display device for a vehicle comprising an electroluminescent element;

FIG. 3A is a diagram of an electroluminescent element demonstrating a front view;

FIG. 3B is a diagram of an electroluminescent element demonstrating a side cross-sectional view;

FIG. 4A is a diagram of an electroluminescent element demonstrating a front view;

FIG. 4B is a diagram of an electroluminescent element demonstrating a side cross-sectional view;

FIG. 5A is a diagram of an electroluminescent element demonstrating a front view;

FIG. 5B is a diagram of an electroluminescent element demonstrating a side cross-sectional view;

FIG. 6A is a diagram of an electroluminescent element demonstrating a front view; and

FIG. 6B is a diagram of an electroluminescent element demonstrating a side cross-sectional view in accordance with the disclosure.

### DETAILED DESCRIPTION

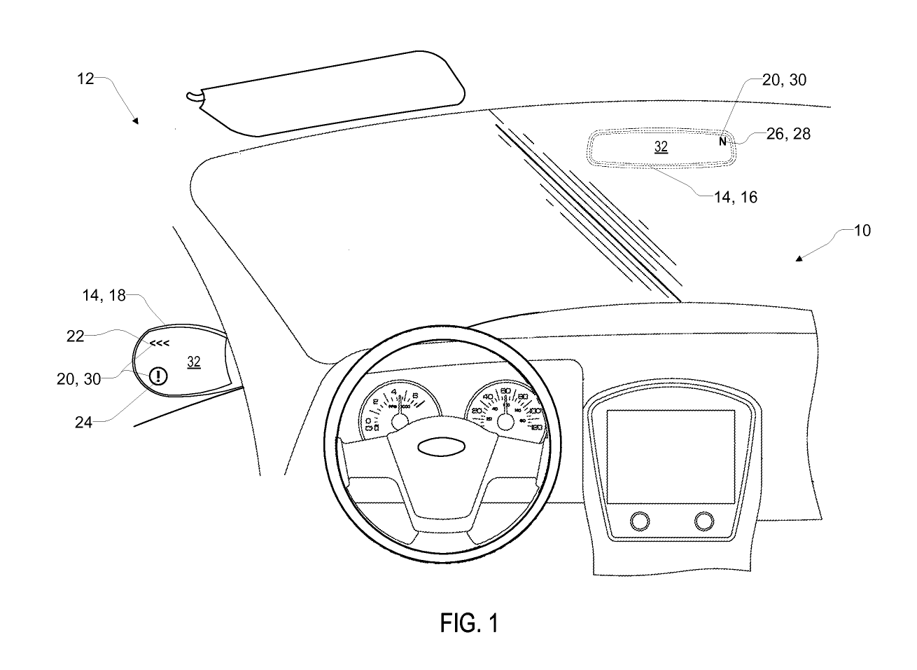

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

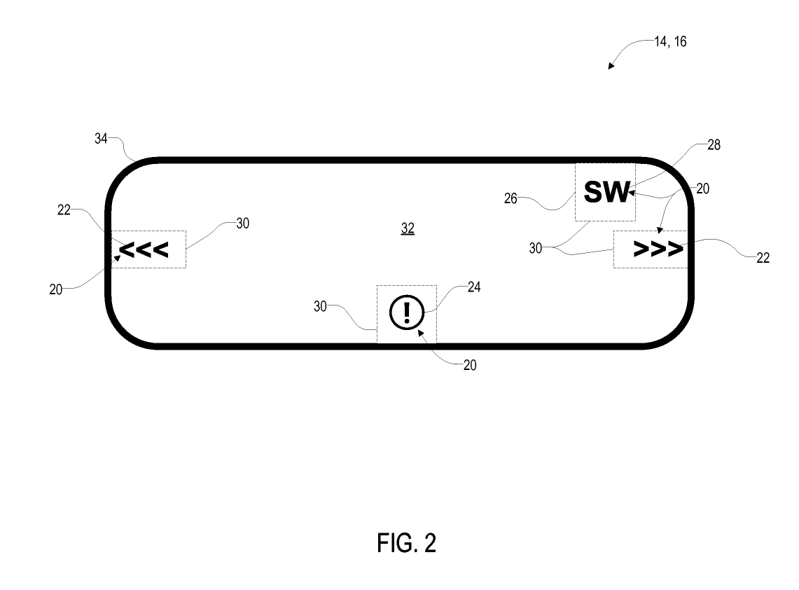

Referring to FIGS. 1 and 2, a passenger compartment 10 of a vehicle 12 is shown demonstrating at least one display device 14. As discussed herein, the display device 14 may correspond to an interior rearview device 16, a side rearview device 18, or any other form of display device utilized in the vehicle 12 as described herein. Each of the display devices 14 may correspond to an electro-optic device configured to adjust a level of brightness of a projection of a scene located rearward from the vehicle 12 to provide an operator of the vehicle 12 with a rearward directed view relative to a forward direction of the vehicle. Though the display device 14 is discussed herein in reference to rearview displays (e.g. rearview mirrors), the display device 14 may be utilized in a variety of applications without departing from the spirit of the disclosure.

The interior rearview device 16 and the side rearview device 18 may include at least one electroluminescent element configured to selectively illuminate a notification symbol 20. The notification symbol 20 may correspond to a variety of symbols, characters, shapes, or any other forms configured to notify an operator or passenger of the vehicle 12 of an operating condition, hazard, or any other notification. For example, the notification symbol 20 may correspond to a directional symbol 22, a warning indicator 24, a segmented or matrix display 26, etc. The segmented display may be an alphanumeric display and the matrix display may be a dot matrix display. The electroluminescent element as discussed herein may be configured to have a high level of transparency and a corresponding low level of haze. In some implementations, the haze of the electroluminescent element may be limited to less than 10 percent to ensure that a reflection generated by the rearview device 16 clearly projected to provide a clear image of the rearward scene. In some embodiments, the haze of the electroluminescent element may be less than 5 percent, and in an exemplary implementation, the haze of the electroluminescent element may be less than 2 percent.

The matrix display 26 is shown in FIGS. 1 and 2 as a compass heading indicator 28 configured to display a compass direction (e.g. N, NW, NE, S, etc.). The notification symbol 20 may be selectively illuminated in response to a control signal configured to selectively illuminate the notification symbol 20. In some implementations, the control signal may illuminate a plurality of pixels of the matrix display 26 or a plurality of segments of the segmented display.

A control signal, as discussed herein, may be output from a controller in response to an input. The input may correspond to a signal generated by a switch or sensor. In some implementations, the input may correspond to a signal received from a vehicle system. For example, an input may be received from a vehicle system in response to a vehicle state. Some examples of vehicle states of the vehicle 12 may include an ignition status, a lighting condition, a drive gear selection (e.g. forward, reverse, park, etc.), or any operating condition of the vehicle 12.

The notification symbol 20 may be generated by an electroluminescent feature 30 in communication with a controller. The electroluminescent feature 30 may be of a significantly transparent material that may be substantially imperceptible when inactive. In response to a control signal or a driving current communicated to the electroluminescent feature 30, the notification symbol 20 may be illuminated due an electrical current exciting a photochemical structure of the electroluminescent feature 30. Similarly, each pixel of the matrix display 26 may be significantly transparent when inactive and selectively activated to emit the notification by selectively illuminating specific pixels of the matrix display 26. For example, specific pixels of the matrix display 26 may be activated to illuminate the compass direction 28 on a display surface 32. The display surface 32 may be defined as the outermost surface of the display device 14 extending within a bezel 34.

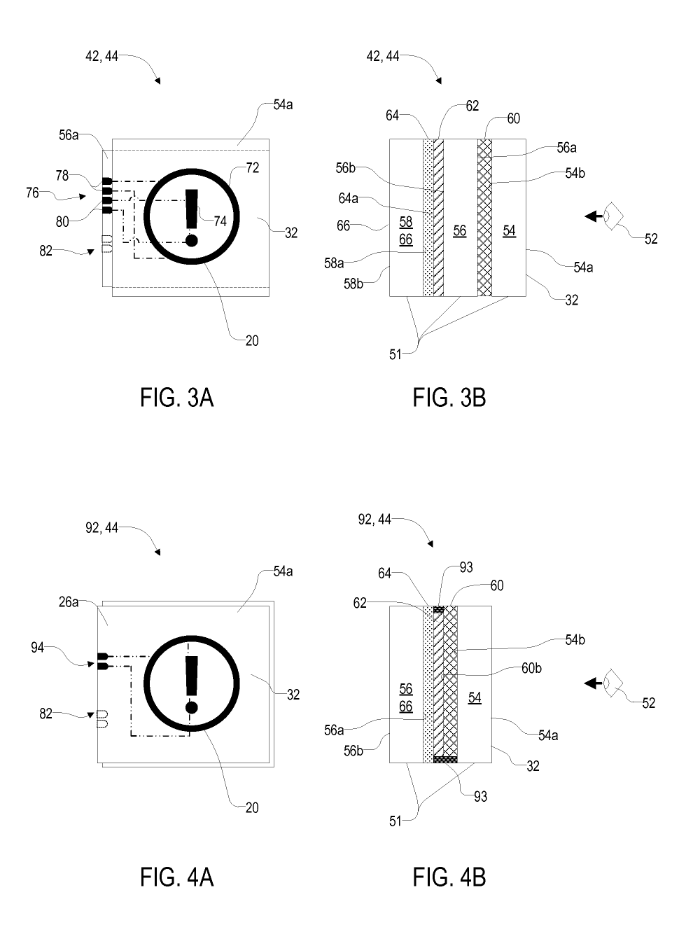

In some implementations, the controller (see, e.g., the controller can be connected to control circuit 80 depicted in FIG. 3 and its corresponding description) is in communication with additional vehicle systems and is operable to selectively activate the notification symbol 20 in response to receiving a signal from the additional vehicle systems. For example, additional vehicle systems may correspond to a blind spot monitoring system, collision detection, traction control, turning indication, or any form of driver assist or notification system. In response to receiving at least one signal from the additional vehicle systems, the controller is operable to activate at least one notification symbol 20 to illuminate the electroluminescent feature 30.

The display device 14 may be implemented as an electro-optic mirror comprising an electrochromic (EC) mirror element. In operation, the controller of the display device 14 is in communication with a glare sensor configured to monitor a level of glare light and control the brightness of the glare light projected from the display device. In response to a detection of glare light, the controller is configured to output a control signal to adjust the reflectivity of the EC mirror element by controlling an EC mirror drive circuitry. In this way, the controller is operable to limit the glare light projected to the operator of the vehicle 12 from approaching headlights.

In some implementations, the EC element may be configured as a window without a reflective layer and may further be utilized to improve a contrast of an image from the display device 14 such that the notification symbol is clearly projected, contrasting from the rearward scene transmitted through the EC element. In such implementations, the EL element is positioned between the viewer and the EC element, a light sensor (e.g. the glare sensor) may detect a high ambient light level. The high ambient level condition may correspond to bright sunlight illuminating the background image behind the display device 14. In response to the high ambient light level occurring during the display of the notification symbol 20, the display device 14 may be operable to dim the EC mirror element to improve a contrast of the notification symbol 20.

The glare light sensor of the electro-optic mirror may be implemented as digital photodiode light sensors as described in U.S. patent application Ser. No. 09/307,191 entitled “PHOTODIODE LIGHT SENSOR,” filed Jan. 25, 2000, now U.S. Pat. No. 6,359,274, and U.S. patent application Ser. No. 09/491,192 entitled “VEHICLE EQUIPMENT CONTROL WITH SEMICONDUCTOR LIGHT SENSORS,” filed May 7, 1999, now U.S. Pat. No. 6,379,013, the disclosures of which are incorporated herein by reference. The EC mirror drive 58 may be implemented by the drive circuit described in U.S. Pat. No. 5,956,012, entitled “SERIES DRIVE CIRCUIT,” filed by Robert R. Turnbull et al. on Sep. 16, 1997, and PCT Application No. PCT/US97/16946, entitled “INDIVIDUAL MIRROR CONTROL SYSTEM,” filed by Robert C. Knapp et al. on Sep. 16, 1997; and U.S. patent application Ser. No. 09/236,969, entitled “AUTOMATIC DIMMING MIRROR USING SEMICONDUCTOR LIGHT SENSOR WITH INTEGRAL CHARGE COLLECTION,” filed May 7, 1999, by Jon H. Bechtel et al., now abandoned, the disclosures of which are incorporated herein by reference thereto. In response to the control signal from the controller, the EC mirror drive may adjust the reflectivity of an EC mirror element by adjusting a current supplied to the EC mirror element to adjust the reflectivity of the display device 14.

Referring now to FIGS. 3A and 3B, a first configuration 42 of an electro-optic mirror stack 44 is shown. FIGS. 3A and 3B demonstrate the mirror stack 44 in a front view and a detailed side cross-sectional view respectively. FIG. 3B demonstrates a plurality of layers or elements of the mirror stack 44. Each of the elements may vary in thickness depending on a particular implementation and are pictured in distorted proportions such that each of the elements of the mirror stack 44 is visible. Additional configurations of the electroluminescent feature 30 of the display device 14 are discussed in reference to FIGS. 4-6 and are also demonstrated in distorted proportions to show details of each configuration.

The mirror stack 44 is configured to reflect light corresponding to a scene rearward of the vehicle 12 in a viewing direction 52. In the first configuration 42, the plurality of elements of the mirror stack 44 comprises a plurality of transparent elements 51 including a first transparent element 54, a second transparent element 56, and a third transparent element 58. Each of the transparent elements 54, 56, and 58 comprises a first side 54a, 56a, and 58a (e.g. front side) and a second side 54b, 54b, and 58b (e.g. rear side), wherein the first side corresponds to the side closer to an origin of the viewing direction 52 relative to the second side. The mirror stack 44 further comprises an electroluminescent element 60, an electrochromic element 62, and a reflective element 64. For clarity, each of the elements of various mirror stacks discussed herein (e.g. elements 54-64) will be referred to using common reference numerals corresponding to like structures. It will be apparent to those skilled in the art that the examples discussed herein may be further modified without departing from the spirit of the disclosure.

Still referring to FIGS. 3A and 3B, each of the transparent elements 54, 56, and 58 may be of any material which is substantially transparent and has sufficient strength and durability to be able to operate in vehicle operating conditions (e.g., varying temperatures and pressures, and protect and contain the electrochromic and electroluminescent elements commonly found in the automotive environment). The first and second transparent elements 54, 56 may comprise any type of borosilicate glass, sapphire, polycarbonate, cyclic olefin, polyester, nylon, acrylic, soda lime glass, float glass or any other material, such as, for example, a polymer or plastic, that is transparent in the visible region of the electromagnetic spectrum. The first and second transparent elements 54, 56 may, in some aspects, correspond to sheets of glass with a thickness ranging from 0.01 inches to about 0.4 inches.

In some implementations, the third transparent element 58 may be constructed similar to the first and second transparent elements 54 and 56. In such implementations, the third transparent element 58 may be coated and/or abut the reflective element 64 or a transflective element. In some implementations, the third transparent element 58 may be of a semitransparent or opaque material due to reflective element 64 being configured to project light toward the viewing direction 52. In such implementations, the third transparent element 58 may be referred to as a rear element 66. In implementations including two or four transparent elements (as discussed in reference to FIGS. 4 and 6), the rear element 66 may correspond to a leftmost element (e.g. furthest from an origin of the viewing direction 52). In implementations including a semitransparent or opaque rear element 66, the rear element 66 may be of a polymeric, metallic, silica, and/or ceramic material. In an exemplary implementation, the rear element 66 may comprise a sheet of glass with a thickness ranging from 0.01 inches to about 0.4 inches.

Referring again to FIGS. 3A and 3B, the electroluminescent element 60 is configured of a transparent material such that the light reflected in the viewing direction passes through the electroluminescent element 60. The material of the electroluminescent element 60 is configured to allow light to pass through in the viewing direction 52 without significantly altering or scattering the light reflected from the reflective element 64 through the electrochromic element 62, the electroluminescent element 60, and each of the transparent elements 54, 56. In an exemplary implementation, the electroluminescent element may 60 have a haze level of less than 10 percent. In some embodiments, the haze of the electroluminescent element may be less than 5 percent, and in an exemplary implementation, the haze of the electroluminescent element may be less than 2 percent.

An electroluminescent layer within the electroluminescent element 60 may comprise a thin film electroluminescent element or structure that may include or consist of a variety of electroluminescent materials, each configured to output a desired color spectrum of light to illuminate the notification symbol 20. For example, the notification symbol 20 may be illuminated by a zinc sulfide material doped with copper to produce a greenish emission, a silver material to produce a bright blue light, and/or a zinc sulfide material doped with manganese to produce an orange-red color. An example of an electroluminescent element that may comprise similar construction to that discussed herein is the Lumineq Tasel display by Beneq.

The electroluminescent element 60 may further comprise a plurality of segments comprising a first segment 72 and a second segment 74. Each of the segments 72, 74 is in communication with electroluminescent control terminals 76 including a first electroluminescent control circuit 78 and a second electroluminescent control circuit 80. Each of the electroluminescent control circuits 78, 80 may be in communication with the controller (not shown). The controller is operable to supply current to each of the electroluminescent control circuits 78, 80 to illuminate each of the segments 72, 74 of the notification symbol 20 independently. As discussed previously, in some implementations, the electroluminescent element 60 may comprise a matrix display 26. In such implementations, the controller may be operable to selectively activate a plurality of pixels of the matrix to display various symbols and characters.

Each of the electroluminescent control circuits 78, 80 may be substantially transparent to allow the light to reflect from the reflective element 64 without distorting the reflected light. In some aspects, the control circuits 78, 80 may include one or more layers of indium-tin oxide (ITO) and various other conductive transparent materials, for example carbon nano-tubes, etc. In this way, control signals may be delivered to each of the segments 72, 74 without distorting the light reflected from the reflective element 64. In the first configuration 42, each of the electroluminescent control circuits 78, 80 may be affixed or deposited on the first surface 56a and/or the second surface 54b such that the control signal may be in communication with each of the electroluminescent segments 72, 74.

The electrochromic element 62 may comprise an electrochromic material configured to change in transparency in response to a dimming signal from the controller. As discussed previously, the dimming signal may be sent by the controller in response to a detection of a glare light from a light sensor. The electrochromic material may be sealed in a chamber that is significantly co-extensive with the display surface 32 as shown in FIGS. 1-2. The electrochromic element 62 as well as the other elements of the mirror stack 44 may be enclosed by the bezel 34 around the edges of the display surface 32. The bezel 34 may correspond to a profile shape of the display surface 32 and/or may correspond to an outline of the surface 32.

Again referring to FIGS. 3A and 3B, the dimming signal may be communicated from the controller to the electrochromic element 62 via electrochromic control terminals 82. The electrochromic control terminals 82 may be disposed on the second surface 56b. The control terminals 82 may comprise a multi-layer coating of a transparent electrically conductive material (e.g. ITO) deposited on the second side 56b of the second transparent element 56 to act as an electrode. An additional transparent electrode may be deposited on the second surface 56b or a first surface 64a of the reflective element 64. The reflective element 64 may also be a conductor. In this configuration, the electrochromic element 62 is in communication with the controller such that the controller is operable to control the transparency and corresponding brightness of the light reflected from the display device 14. Examples of electrochromic elements as described herein are further discussed in U.S. Pat. Nos. 5,066,112 A; 5,818,625 A; 5,923,457 A; and 6,700,693 B2 each of which are incorporated herein by reference in their entirety.

The reflective element 64 may comprise a transflective or reflective material deposited or adhered to the first side 58a of the third transparent element 58. A transflective layer may refer to a mirror layer that is partially reflective and partially transmissive generally across the entire visible spectrum so as to enable a full color display to be positioned proximate the second surface 58b of the third transparent element 58. Suitable materials for the reflective element 64 may include silver alloys of silver/palladium, silver/gold, silver/platinum, silver/rhodium, silver/titanium, etc. and platinum or platinum group metals such as rhodium, ruthenium, osmium, etc. on their alloys. The amount of the solute material (e.g. palladium, gold, etc.) may vary for a particular reflective layer. Examples of reflective and transflective materials and corresponding reflective layers are discussed in U.S. Pat. Nos. 8,035,881 B2; 8,339,526 B2; 8,582,052 B2; each of which are incorporated herein by reference in their entirety.

One or more of the electroluminescent element 60, the electrochromic element 62, and the reflective element 64 may be affixed to or bonded to one of the transparent elements 54, 56, and 58. For example in the first configuration 42, the electroluminescent element 60 may be applied as a thin film coating on the second surface 54b, the electrochromic element may be affixed to the second surface 56b, and the reflective element 64 may be applied as a thin film coating the first surface 58a. Each of the transparent elements 54, 56, and 58 may further be bonded or fused together by a transparent adhesive to form the mirror stack 44. In this way, one or more of the manufacturing operations for the transparent element 54, 56, and 58 may be divided and inspected to ensure the proper operation of the mirror stacks throughout manufacture.

The display device 14 comprising the electro-optic mirror stack 44 as discussed herein is operable to control the light emitted from the display surface 32 by controlling the variable reflectivity of the electrochromic element 62 to limit a glare light projected from the display surface 32. In operation, the display surface 32 is configured to reflect light corresponding to a scene rearward of the vehicle 12 in the viewing direction 52 to provide substantially consistent reflectivity across the entirety of the display surface 32. The display device is further operable to illuminate at least one notification symbol 20 that is configured to illuminate a portion of the display surface to reveal the notification symbol 20.

Referring now to FIGS. 4A and 4B, a second configuration 92 of the electro-optic mirror stack 44 is shown. Similar to FIG. 3, FIGS. 4A and 4B demonstrate the mirror stack 44 according to the second configuration 92 in a front view and a detailed side cross-sectional view respectively. The second configuration 92 of the mirror stack 44 is similarly configured to reflect light corresponding to a scene rearward of the vehicle 12 in the viewing direction 52. In the second configuration 92, the plurality of transparent elements 51 includes the first transparent element 54 and the second transparent element 56. The mirror stack 44 further comprises the electroluminescent element 60, the electrochromic element 62, and the reflective element 64.

In the second configuration 92, the electroluminescent element 60, the electrochromic element 62, and the reflective element 64 are disposed between the first transparent element 54 and the second transparent element 56. In this configuration, the electroluminescent element 60 may be applied as a thin film coating on the second surface 54b. Further the reflective element 64 may be disposed as a coating and/or a thin film deposited on or adhered to the first surface 56a. The electrochromic element 62 may be disposed between the electroluminescent element 60 and the reflective element 64, and bonded or fused together by a transparent adhesive or a perimeter seal 93 to form the mirror stack 44. The position of the electrochromic element 62 and the electroluminescent element 60 can be inverted such that the electrochromic element 62 is adjacent reflective element 64.

In the second configuration 92 depicted in FIG. 4, the notification symbol 20 is shown configured as a single segment in communication with the control terminals 94 disposed on the second side 54b. The control terminals 94 are in communication with the controller such that the controller is operable to selectively illuminate the notification symbol 20 by supplying a signal to the electroluminescent element 60. The electrochromic element 62 is further in communication with the controller via the control terminals 82. In the second configuration 92, the electrochromic control terminals 82 may be disposed on the second surface 60b of the electroluminescent element 60. Though the notification symbol 20 and the corresponding electroluminescent element 60 are discussed in the various configurations of the mirror stack 44 as a single segment, multiple segments, and/or a display matrix, it shall be understood that the particular type of notification symbol 20 and corresponding segments and/or pixels may vary among the configurations of the mirror stack 44.

The second configuration 92 provides for the display device to have a small cross-section and reduced material due to fewer transparent layers being utilized. These characteristics of the second configuration 92 may provide cost savings in manufacturing and materials. Similar to the first configuration 42 (see FIG. 3), the second configuration 92 of the electro-optic mirror stack 44 depicted in FIG. 4, is configured to provide a uniform reflectivity from the display surface 32 while providing for a hidden notification symbol 20 that may be selectively activated to provide a warning or other information to an operator of the vehicle 12.

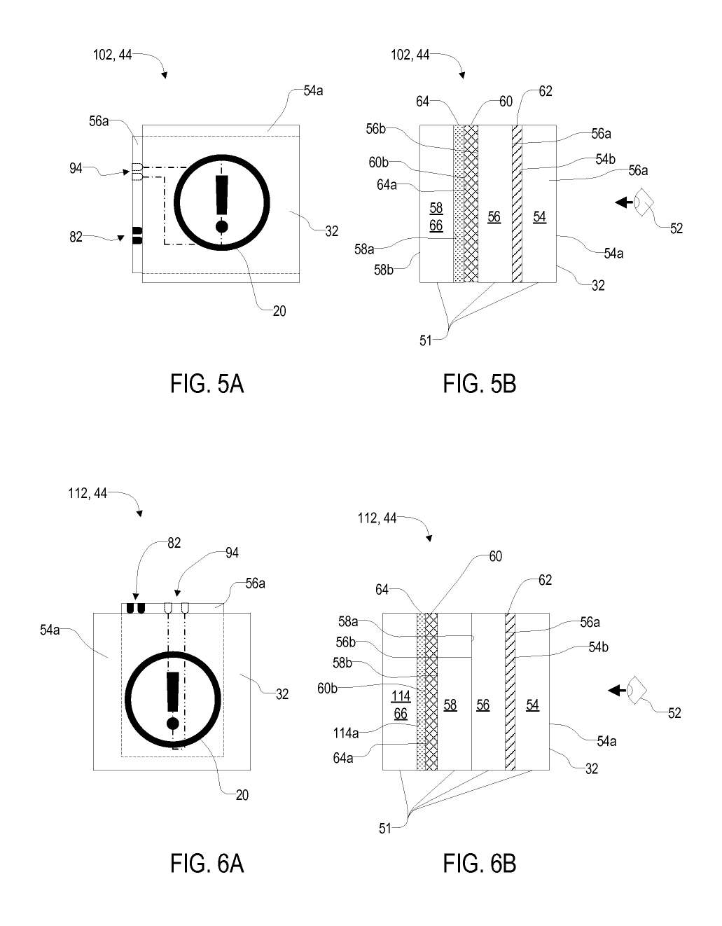

Referring to FIGS. 5A and 5B, a third configuration 102 of the electro-optic mirror stack 44 is shown. Similar to FIGS. 3 and 4, FIGS. 5A and 5B demonstrate the mirror stack 44 of the third configuration 102 in a front view and a detailed side cross-sectional view respectively. The third configuration 102 of the mirror stack 44 is also similarly configured to the configurations 42, 92 in so far as it reflects light corresponding to a scene rearward of the vehicle 12 in the viewing direction 52. In the third configuration 102, the plurality of transparent elements 51 includes the first transparent element 54, the second transparent element 56, and the third transparent element 58. The mirror stack 44 further comprises the electroluminescent element 60, the electrochromic element 62, and the reflective element 64.

In the third configuration 102, the electroluminescent element 60 is arranged adjacent to the reflective element 64 to limit the distance between notification symbol 20 and the image of symbol 20 reflected off of reflective element 64. In some implementations, the transparent elements 54, 56, and 58 may be sufficiently thick that that the emission from the electroluminescent element 60 may be reflected back from the first surface 64a of the reflective element 64. This may result in a double image being projected outward through the display surface 32. In such implementations, it may be advantageous to position the electroluminescent element 60 close to the reflective element 64 to prevent and limit the reflection of the notification symbol 20 from the first surface 64a.

In the third configuration 102, the reflective element 64 is disposed adjacent to the first surface 58a of the third transparent element 58 which may be semi-transparent or opaque. The electroluminescent element 60 is affixed and/or deposited on the first surface 64a of the reflective element 64. Additionally, the electrochromic element 62 is disposed between the first transparent element 54 and the second transparent element 56. In this arrangement, the first and second transparent elements 54, 56 may be secured to (such as with a perimeter seal 93) and/or laminated to the third transparent element 58 thereby sealing the electroluminescent element 60 and the reflective element 64 therebetween.

In the third configuration 102, the notification symbol 20 is configured as a single segment in communication with control terminals 94 disposed on the first surface 56a. The control terminals 94 are in communication with the controller such that the controller is operable to selectively illuminate the notification symbol 20 by supplying a signal to the electroluminescent element 60. The electrochromic element 62 is further in communication with the controller via the control terminals 82. In the third configuration 102, the electrochromic control terminals 82 may be disposed on the second surface 54b and/or the first surface 56a.

Referring now to FIGS. 6A and 6B, a fourth configuration 112 of the electro-optic mirror stack 44 is shown. FIGS. 6A and 6B demonstrate the mirror stack 44 of the fourth configuration 112 in a front view and a detailed side cross-sectional view respectively. The fourth configuration 112 of the mirror stack 44 is similarly configured to the configurations 42, 92, and 102 insofar as it reflects light corresponding to a scene rearward of the vehicle 12 in the viewing direction 52. In the fourth configuration 112, the plurality of transparent elements 51 includes the first transparent element 54, the second transparent element 56, the third transparent element 58, and a fourth transparent element 114. The mirror stack 44 further comprises the electroluminescent element 60, the electrochromic element 62, and the reflective element 64.

In the fourth configuration 112, the electroluminescent element 60 is arranged adjacent to the reflective element 64 to limit a reflection of the notification symbol 20, as discussed above in reference to configuration 102 depicted in FIG. 5. The electroluminescent element 60 in the fourth configuration 112 is arranged close to the reflective element 64 to minimize the distance between symbol 20 and the reflected image of symbol 20 off of reflective element 64. Including the electroluminescent element 60 adjacent to the reflective element 64 can be increasingly important in the fourth configuration 112 due to a potential increase in thickness of the mirror stack 44 corresponding to the fourth transparent element 114. For example, if the positions of the electrochromic element 62 and the electroluminescent element 60 were reversed, the distance between the first surface 64a and the electroluminescent layer 60 may increase sufficiently to cause a double image of the notification symbol 20 due to the reflection from the first surface 64a.

In the fourth configuration 112 depicted in FIG. 6, the reflective element 64 is disposed on the first surface 114a of the fourth transparent element 114. The electroluminescent element 60 is affixed and/or deposited on the second surface 58b of the third transparent element 58. Additionally, the electrochromic element 62 is disposed between the first transparent element 54 and the second transparent element 56. In this arrangement, the first and second transparent elements 54 and 56 may be secured to and/or laminated to the third transparent element 58. Further, the electroluminescent element 60 and the reflective element 64 may be sealed between the third and fourth transparent elements 58, 114 thereby sealing the electroluminescent element 60 and the reflective element 64 therebetween. The second surface 60b of the electroluminescent element 60 may be secured to the first surface 64a of the reflective element 64 with transparent adhesive.

In the fourth configuration 112, the notification symbol 20 is configured as a single segment in communication with control terminals 94 disposed on the second side 58b. The control terminals 94 are in communication with the controller such that the controller is operable to selectively illuminate the notification symbol 20 by supplying a signal to the electroluminescent element 60. The electrochromic element 62 is in communication with the controller via the control terminals 82. In the fourth configuration 112, the electrochromic control terminals 82 may be disposed on the second surface 54b and/or the first surface 56a. The fourth transparent element 114 of the fourth configuration 112 may improve and/or enhance the durability of the mirror stack 44 due to the structural support provided by this additional transparent structure. As discussed herein, in some implementations, the fourth transparent layer 114 may correspond to the rear element 66. The rear element 66 may be translucent, semitransparent or opaque.

Each of the various configurations of the electro-optic mirror stack 44 discussed herein may have various benefits that may be utilized for specific applications of the display device 14. The display device 14 may provide for an improved electro-optic mirror having an electroluminescent element that may be utilized to clearly illuminate a variety of notifications symbols in various colors and combinations thereof. It is to be understood that variations and modifications can be made on the aforementioned structures and methods without departing from the concepts of the present device, and further it is to be understood that such concepts are intended to be covered by the following claims unless these claims by their language expressly state otherwise.

The above description is considered to be that of the illustrated embodiments only. Modifications of the device will occur to those skilled in the art and to those who make or use the device. Therefore, it is understood that the embodiments shown in the drawings and described above are merely for illustrative purposes and not intended to limit the scope of the device, which is defined by the following claims as having a scope according to the principles of patent law, including the Doctrine of Equivalents.

The invention claimed is:

1. A display device for a vehicle, comprising:
at least one transparent element having a profile shape;
a reflective element abutting a first surface of the transparent element;
an electroluminescent element proximate the reflective element; and
an electrochromic element proximate the electroluminescent element, wherein the electroluminescent element is substantially transparent in an inactive state and configured to illuminate at least a portion of a symbol in response to receiving a driving current.

2. The display device according to claim 1, wherein the elements are arranged in a stacked configuration.

3. The display device according to claim 2, wherein the stacked configuration is arranged such that the electroluminescent element is located at a distance of less than 5 mm from the reflective element to limit a reflection of the symbol.

4. The display device according to claim 1, wherein the electroluminescent element is substantially transparent in the inactive state.

5. The display device according to claim 1, wherein the electroluminescent element is applied as a thin film coating on the at least one transparent element.

6. The display device according to claim 1, wherein each of the reflective element and the electrochromic element extends substantially along the profile shape.

7. The display device according to claim 1, wherein the at least one transparent element comprises a plurality of transparent elements, each of the transparent elements abutting one or more of the electroluminescent element, the reflective element, and the electrochromic element.

8. The display device according to claim 1, wherein the reflective element is a transflective element.

9. A reflective display device for a vehicle having a stacked configuration, the display device comprising:
a reflective electroluminescent assembly comprising:
a reflective element;
an electroluminescent element forming an electroluminescent feature proximate the reflective element;
an electrochromic element proximate the electroluminescent element; and
at least one transparent element forming a display surface of the reflective electroluminescent assembly, wherein the electroluminescent element is configured to:
display the electroluminescent feature on the display surface in response to an electrical signal; and
transmit light from the display surface, reflected from the reflective element, and through the electroluminescent element in an idle state.

10. The display device according to claim 9, wherein the idle state corresponds to the electroluminescent feature being unilluminated.

11. The display device according to claim 9, wherein the transmitted light is configured to communicate a reflected scene.

12. The display device according to claim 9, wherein the reflected scene is reflected through the display surface with approximately less than 10% haze limiting the light from the display surface.

13. The display device according to claim 12, wherein the electrochromic element is configured to selectively control a level of brightness of the reflected scene.

14. The display device according to claim 13, wherein the electrochromic element is configured to selectively limit a level of brightness of the reflected scene without limiting an illumination of the electroluminescent feature.

15. The display device according to claim 9, wherein the electroluminescent feature corresponds to a symbol.

16. A reflective display device for a vehicle, the display device comprising:
a reflective electroluminescent assembly comprising:
a reflective element;
an electroluminescent element forming an electroluminescent feature proximate the reflective element;
an electrochromic element proximate the electroluminescent element; and
at least one transparent element forming a display surface of the reflective electroluminescent assembly, wherein the electroluminescent element comprises a plurality of segments configured to emit light forming at least one symbol.

17. The display device according to claim 16, wherein the segments correspond to at least one of a segment of a segmented display and a pixel of a matrix display.

18. The display device according to claim 16, wherein at least one segment of the plurality of segments is configured to have a high level of transparency corresponding to a level of haze approximately less than 10 percent.

19. The display device according to claim 18, wherein the high level of transparency provides for reflected light to be clearly projected from the display device to provide a clear image of a scene rearward of the vehicle.

20. The display device according to claim 18, wherein the level of haze is approximately less than 5 percent.
